(19) United States
(12) Patent Application Publication
(10) Pub. No.: US 2022/0139423 A1
(43) Pub. Date: May 5, 2022

(54) MAGNETIC RECORDING MEDIUM

(71) Applicant: Sony Group Corporation, Tokyo (JP)

(72) Inventors: Takashi KATAGUCHI, Tokyo (JP); Masaru TERAKAWA, Tokyo (JP); Takeshi TAKAHASHI, Tokyo (JP); Natsuki ICHISE, Tokyo (JP); Katsunori MAESHIMA, Tokyo (JP)

(21) Appl. No.: 17/431,096

(22) PCT Filed: Feb. 14, 2020
(86) PCT No.: PCT/JP2020/005826

§ 371 Date: Aug. 13, 2021

(30) Foreign Application Priority Data
Feb. 15, 2019 (JP) 2019-025770

(51) Int. Cl. G11B 5/714; G11B 5/706

(52) U.S. Cl. CPC G11B 5/714; G11B 5/70678; G11B 5/70621

(57) ABSTRACT

[Solving Means] A tape-shaped magnetic recording medium includes: a base; and a magnetic layer that is provided on the base and includes a magnetic powder. The magnetic powder includes magnetic particles that have a uniaxial crystal magnetic anisotropy and contain cobalt ferrite. A ratio L4/L2 of a component L4 having a multiaxial crystal magnetic anisotropy to a component L2 having a uniaxial crystal magnetic anisotropy is 0 or more and 0.25 or less, the components being obtained by applying Fourier transformation to a torque waveform of the magnetic recording medium.

### TECHNICAL FIELD

The present disclosure relates to a magnetic recording medium.

### BACKGROUND ART

In recent years, a tape-shaped magnetic recording medium has attracted attention as a data storage medium.

For the tape-shaped magnetic recording medium, various types of magnetic powders have been studied in order to achieve high recording density. A cobalt ferrite magnetic powder with a high saturation magnetization σs and a high coercive force Hc is expected to be one of the optimal magnetic powders for the next-generation tape-shaped magnetic recording medium.

Patent Literature 1 describes a magnetic recording medium for high-density recording using spinel ferrimagnetic particles represented by a compositional formula: (MO).n/2(Fe₂O₃) (in the formula, M represents a divalent metal and n=Fe/M (molar ratio) satisfies the relationship of 2.05<n<2.5).

### CITATION LIST

### Patent Literature

Patent Literature 1: Japanese Patent Application Laid-open No. 2006-229037

### DISCLOSURE OF INVENTION

### Technical Problem

However, the magnetic recording medium using a cobalt ferrite magnetic powder has a problem that noises are large.

It is an object of the present disclosure to provide a magnetic recording medium capable of reducing noises.

### Solution to Problem

In order to achieve the above-mentioned object, the present disclosure is a tape-shaped magnetic recording medium, including: a base; and a magnetic layer that is provided on the base and includes a magnetic powder, in which the magnetic powder includes magnetic particles that have a uniaxial crystal magnetic anisotropy and contain cobalt ferrite, and a ratio L4/L2 of a component L4 having a multiaxial crystal magnetic anisotropy to a component L2 having a uniaxial crystal magnetic anisotropy is 0 or more and 0.25 or less, the components being obtained by applying Fourier transformation to a torque waveform of the magnetic recording medium.

### BRIEF DESCRIPTION OF DRAWINGS

FIG. 1 is a cross-sectional view of a magnetic recording medium according to an embodiment of the present disclosure.

Part A of FIG. 2 is a graph showing a magnetic torque waveform of a magnetic tape according to an Example 2. Part B of FIG. 2 is a graph showing a magnetic torque waveform of a magnetic tape according to a Comparative Example 1. Part C of FIG. 2 is a graph showing a magnetic torque waveform of a magnetic tape according to a Comparative Example 2.

FIG. 3 is a graph showing the noise spectrum of the magnetic tapes according to the Example 2 and Comparative Examples 1 and 2.

### MODE(S) FOR CARRYING OUT THE INVENTION

An embodiment of the present disclosure will be described in the following order.
1 Configuration of magnetic recording medium
2 Method of producing magnetic powder
3 Method of producing magnetic recording medium
4 Effects

[1 Configuration of Magnetic Recording Medium]

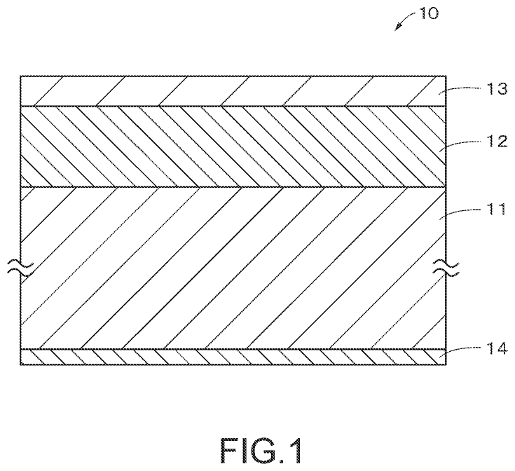

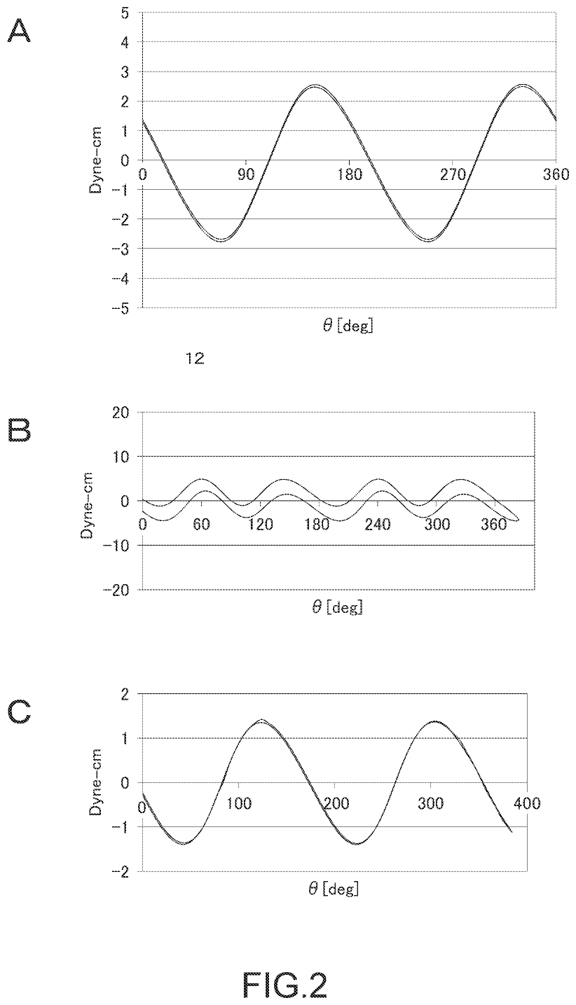

First, a configuration of a magnetic recording medium 10 according to an embodiment will be described with reference to FIG. 1. The magnetic recording medium 10 includes an elongated base 11, a underlayer 12 provided on one main surface of the base 11, a magnetic layer 13 provided on the underlayer 12, and a back layer 14 provided on the other main surface of the base 11. Note that the underlayer 12 and the back layer 14 are provided as necessary and do not necessarily need to be provided.

The magnetic recording medium 10 has an elongated tape-like shape, and is caused to travel in a longitudinal direction during recording and reproduction. From the viewpoint of improving the recording density, the magnetic recording medium 10 is configured to be capable of recording a signal at the shortest recording wavelength of favorably 50 nm or less, more favorably 46 nm or less. In view of the effect of the magnetic powder size on transition widths, the magnetic recording medium 10 is configured to be capable of recording a signal at the shortest recording wavelength of favorably 30 nm or more. The line recording density of the magnetic recording medium 10 is favorably 500 kbpi or more and 850 kbpi or less.

The magnetic recording medium 10 is favorably used in a recording/reproduction apparatus including a ring-type head as a recording head. The magnetic recording medium 10 may be used in a library apparatus. In this case, the library apparatus may include a plurality of recording/reproduction apparatuses described above.

Note that in this specification, the “perpendicular direction” means a direction perpendicular to the surface of the magnetic recording medium 10 in a flat state (i.e., the thickness direction of the magnetic recording medium 10), and the “longitudinal direction” means a longitudinal direction (traveling direction) of the magnetic recording medium 10.

(Base)

The base 11 is a non-magnetic support that supports the underlayer 12 and the magnetic layer 13. The base 11 has an elongated film-like shape. The upper limit value of the average thickness of the base 11 is favorably 4.2 μm or less, more favorably 3.8 μm or less, and still more favorably 3.4 μm or less. When the upper limit value of the average thickness of the base 11 is 4.2 μm or less, the recording capacity in one data cartridge can be made higher than that of a typical magnetic recording medium. The lower limit value of the average thickness of the base 11 is favorably 3 μm or more. When the lower limit value of the average thickness of the base 11 is 3 μm or more, a reduction in the strength of the base 11 can be suppressed.

The average thickness of the base 11 is obtained as follows. First, the magnetic recording medium 10 having a ½-inch width is prepared and cut into the length of 250 mm to prepare a sample. Subsequently, layers other than the base 11 of the sample (i.e., the underlayer 12, the magnetic layer 13, and the back layer 14) are removed with a solvent such as MEK (methyl ethyl ketone) and dilute hydrochloric acid. Next, the thickness of the sample (the base 11) is measured at positions of five or more points using a laser hologage manufactured by Mitutoyo as a measuring apparatus, and the measured values are simply averaged (arithmetically averaged) to calculate the average thickness of the base 11. Note that the measurement positions are randomly selected from the sample.

The base 11 contains, for example, at least one of polyesters, polyolefins, cellulose derivatives, vinyl resins, and different polymeric resins. When the base 11 contains two or more of the above-mentioned materials, the two or more materials may be mixed, copolymerized, or stacked.

The polyesters include, for example, at least one of PET (polyethylene terephthalate), PEN (polyethylene naphthalate), PBT (polybutylene terephthalate), PBN (polybutylene naphthalate), PCT (polycyclohexylene dimethylene terephthalate), PEB (polyethylene-p-oxybenzoate), or polyethylene bisphenoxycarboxylate.

The polyolefins include, for example, at least one of PE (polyethylene) or PP (polypropylene). The cellulose derivatives include, for example, at least one of cellulose diacetate, cellulose triacetate, CAB (cellulose acetate butyrate), or CAP (cellulose acetate propionate). The vinyl resins include, for example, at least one of PVC (polyvinyl chloride) or PVDC (polyvinylidene chloride).

The different polymeric resins include, for example, at least one of PA (polyamide, nylon), aromatic PA (aromatic polyamide, aramid), PI (polyimide), aromatic PI (aromatic polyimide), PAI (polyamideimide), aromatic PAI (aromatic polyamideimide), PBO (polybenzoxazole, e.g., Zylon (registered trademark)), polyether, PEK (polyetherketone), polyetherester, PES (polyethersulfone), PEI (polyetherimide), PSF (polysulfone), PPS (polyphenylene sulfide), PC (polycarbonate), PAR (polyarylate), or PU (polyurethane).

(Magnetic Layer)

The magnetic layer 13 is a perpendicular recording layer for recording signals. The magnetic layer 13 has a uniaxial magnetic anisotropy in the perpendicular direction. That is, the easy axis of magnetization of the magnetic layer 13 is directed to the perpendicular direction. The magnetic layer 13 includes, for example, a magnetic powder and a binder. The magnetic layer 13 may further include, as necessary, at least one additive of a lubricant, an antistatic agent, an abrasive, a curing agent, a rust inhibitor, or a non-magnetic reinforcing particle.

The average thickness of the magnetic layer 13 is favorably 40 nm or more and 90 nm or less, more favorably 40 nm or more and 70 nm or less, still more favorably 40 nm or more and 60 nm or less, and particularly favorably 40 nm or more and 50 nm or less. When an average thickness t of the magnetic layer 13 is 40 nm or more, since output can be ensured in the case where an MR-type head is used as the reproduction head, it is possible to improve the electromagnetic conversion characteristics. Meanwhile, when the average thickness of the magnetic layer 13 is 90 nm or less, since the magnetization can be uniformly recorded in the thickness direction of the magnetic layer 13 in the case where a ring-type head is used as the recording head, it is impossible to improve the electromagnetic conversion characteristics. In this specification, the electromagnetic conversion characteristics are, for example, CNR (Carrier to Noise Ratio).

The average thickness of the magnetic layer 13 is obtained as follows. First, the magnetic recording medium 10 is thinly processed perpendicularly to the main surface thereof by a FIB (Focused Ion Beam) method or the like to prepare a slice, and the cross section of the slice is observed by a transmission electron microscope (TEM) to obtain a TEM image. The apparatus and observation conditions are shown below.

Apparatus: TEM (manufactured by Hitachi, Ltd., H9000NAR)

Acceleration voltage:300 kV

Magnification: 100,000

Next, the obtained TEM image is used to measure the thickness of the magnetic layer 13 at positions of at least 10 points in the longitudinal direction of the magnetic recording medium 10, and then the measured values are simply averaged (arithmetically averaged) to obtain the average thickness of the magnetic layer 13. Note that the measurement positions are randomly selected from the sample piece.

(Magnetic Powder)

The magnetic powder includes magnetic particles containing cobalt ferrite as a main phase (hereinafter, referred to as the “cobalt ferrite particles”). The cobalt ferrite particles have, for example, a cubic shape or a substantially cubic shape. The cobalt ferrite has an inverse-spinel crystalline structure. Note that hereinafter, the magnetic powder including cobalt ferrite particles will be referred to as the cobalt ferrite magnetic powder in some cases.

The cobalt ferrite particles have a uniaxial crystal magnetic anisotropy, and the magnetic powder is oriented in the perpendicular direction. Since the cobalt ferrite particles have a uniaxial crystal magnetic anisotropy, the magnetic powder can be perpendicularly oriented. Further, components other than those in the orientation direction can be reduced. Therefore, the noises of the magnetic recording medium 10 can be reduced. Note that the fact that the cobalt ferrite particles have a uniaxial crystal magnetic anisotropy can be confirmed as follows. The torque waveform is measured in a manner similar to the method of calculating the ratio L4/L2 described below. By checking whether or not the measured torque waveform fluctuates at intervals of 180°, it is possible to confirm that the cobalt ferrite particles have a uniaxial crystal magnetic anisotropy. Further, in the present disclosure, the “orientation direction of the magnetic powder” means a direction in which a larger squareness ratio is obtained, of the perpendicular direction and the longitudinal direction of the magnetic recording medium 10.

The easy axis of magnetization of the cobalt ferrite particles is favorably directed to the perpendicular direction or substantially perpendicular direction. That is, the magnetic powder is favorably dispersed within the magnetic layer 13 such that the square or substantially square surfaces of the cobalt ferrite particles are perpendicular or substantially perpendicular to the thickness direction of the magnetic layer 13. In the case of cubic or substantially cubic cobalt ferrite particles, the area of contact between the particles in the thickness direction of the medium can be reduced and agglomeration of the particles can be suppressed as compared with hexagonal plate-shaped barium ferrite particles. That is, the dispersibility of the magnetic powder can be increased.

It is favorable that the square or substantially square surfaces of the cobalt ferrite particles are exposed from the surface of the magnetic layer 13. Performing short-wavelength recording by a magnetic head on the square or substantially square surfaces of the cobalt ferrite particles is advantageous in terms of high-density recording as compared with the case of performing short-wavelength recording on the hexagonal-shaped surface of the hexagonal plate-shaped barium ferrite magnetic powder having the same volume. From the viewpoint of high-density recording, it is favorable that the surface of the magnetic layer 13 is filled with square or substantially square surfaces of cobalt ferrite particles.

The average particle size of the magnetic powder is favorably 10 nm or more and 25 nm or less, more favorably 10 nm or more and 23 nm or less. When the average particle size is 10 nm or more, the generation of superparamagnetism can be suppressed. Therefore, it is possible to suppress the deterioration of the magnetic properties of the magnetic powder. In the magnetic recording medium 10, a half-sized region of the recording wavelength is an actual magnetized region. For this reason, by setting the average particle size of the magnetic powder to half or less of the shortest recording wavelength, it is possible to achieve favorable electromagnetic conversion characteristics. In the case where the average particle size of the magnetic powder is 25 nm or less, it is possible to achieve favorable electromagnetic conversion characteristics in the magnetic recording medium 10 configured to be capable of recording signals at the shortest recording wavelength of 50 nm or less.

The average particle size of the magnetic powder is obtained as follows. First, the magnetic recording medium 10 is thinly processed perpendicularly to the main surface thereof by the FIB method or the like to prepare a slice, and the cross section of the slice is observed by a scanning transmission electron microscope (STEM) to obtain a STEM image. Next, 100 cobalt ferrite particles are randomly selected from the obtained STEM image, and an area S of each of the particles is obtained. Next, assuming that the cross-sectional shapes of the particles are circular, a particle size (diameter) R of each of the particles is calculated as the particle size from the following formula (1), and the particle size distribution of the magnetic powder is obtained.

R=2×(S/π)½ (1)

Next, the median diameter (50% diameter, D50) is obtained from the obtained particle size distribution, and is used as the average particle size.

Apparatus: STEM (Manufactured by HITACHI, 54800)

Acceleration voltage: 30 kV

Measurement magnification: 200,000

The relative standard deviation of the magnetic powder represented by the following formula (2) is favorably 50% or less.

Relative standard deviation [%]=([Standard deviation of particle size]/[Average particle size])×100 (2)

When the relative standard deviation exceeds 50%, the variation of the particle size of the magnetic powder becomes large, and there is a possibility that the variation of the magnetic properties of the magnetic powder becomes large.

The above-mentioned relative standard deviation of the particle size of the magnetic powder is obtained as follows. First, the average particle size is obtained in a manner similar to the method of calculating the average particle size described above. Next, the standard deviation of the particle size is obtained from the particle size distribution used in obtaining the average particle size. Next, the relative standard deviation is obtained by substituting the average particle size and the standard deviation of the particle size obtained as described above into the above-mentioned formula (2).

It is favorable that some Cos contained in the cobalt ferrite are substituted with at least one selected from the group consisting of Zn, Ge, and a transition metal element other than Fe. By substituting some Cos as described above, it is possible to suppress the variation of the coercive force Hc. The transition metal element is favorably one or more selected from the group consisting of Mn, Ni, Cu, Ta, and Zr, and Cu is particularly favorable among these transition metals.

The cobalt ferrite has, for example, the average composition represented by the following formula (3).

CoₓM_{y}Fe₂O_{z} (3)

(However, in the formula (3), M represents at least one selected from the group consisting of Zn, Ge, and a transition metal element other than Fe. The transition metal element is favorably one or more selected from the group consisting of Mn, Ni, Cu, Ta, and Zr, and Cu is particularly favorable among these transition metals. x represents a value within the range of 0.4≤x≤1.0. y represents a value within the range of 0≤y≤0.3. However, x and y satisfy the relationship of (x+y)≤1.0. z represents a value within the range of 3≤z≤4. Some Fes may be substituted with other metal elements.)

The lower limit value of the saturation magnetization σs of the magnetic powder is favorably 55 emu/g or more, more favorably 60 emu/g or more, still more favorably 65 emu/g or more, and particularly favorably 70 emu/g or more. When the saturation magnetization σs is 55 emu/g or more, since high output can be achieved even in the case where the magnetic layer 13 is thin, it is possible to achieve favorable electromagnetic conversion characteristics. Note that such a high saturation magnetization amount σs can be obtained by the cobalt ferrite magnetic powder, and it is difficult to obtain such a high saturation magnetization amount σs in the barium ferrite magnetic powder. Note that since the saturation magnetization amount σs of the barium ferrite magnetic powder is approximately 50 emu/g and the saturation magnetization amount σs is insufficient for thinning the layer of the magnetic layer 13, the reproduction output of the magnetization signal is weakened and there is a possibility that favorable electromagnetic conversion characteristics cannot be achieved.

The upper limit value of the saturation magnetization amount σs of the magnetic particles is favorably 85 emu/g or less. When the saturation magnetization amount σs exceeds 85 emu/g, since a GMR (Giant Magnetoresistive) head, a TMR (Tunneling Magnetoresistive) head, or the like for reading the magnetization signal is saturated, there is a possibility that the electromagnetic conversion characteristics are reduced.

The above-mentioned saturation magnetization amount σs is obtained as follows. First, a magnetic powder sample having a predetermined shape is prepared. The magnetic powder sample can be freely prepared to the extent that it does not affect the measurement, such as compaction to a capsule for measurement and sticking to a tape for measurement. Next, an M-H loop of the magnetic powder sample is obtained by using a vibrating sample magnetometer (VSM), and then the saturation magnetization amount σs is obtained from the obtained M-H loop. Note that the measurement of the M-H loop described above is performed under an environment of room temperature (25° C.)

(Binder)

Examples of the binder include a thermoplastic resin, a thermosetting resin, and a reactive resin. Examples of the thermoplastic resin include vinyl chloride, vinyl acetate, a vinyl chloride-vinyl acetate copolymer, a vinyl chloride-vinylidene chloride copolymer, a vinyl chloride-acrylonitrile copolymer, an acrylate ester-acrylonitrile copolymer, an acrylate ester-vinyl chloride-vinylidene chloride copolymer, an acrylate ester-acrylonitrile copolymer, an acrylate ester-vinylidene chloride copolymer, a methacrylic acid ester-vinylidene chloride copolymer, a methacrylic acid ester-vinyl chloride copolymer, a methacrylic acid ester-ethylene copolymer, polyvinyl fluoride, a vinylidene chloride-acrylonitrile copolymer, an acrylonitrile-butadiene copolymer, a polyamide resin, polyvinyl butyral, a cellulose derivative (cellulose acetate butyrate, cellulose diacetate, cellulose triacetate, cellulose propionate, nitrocellulose), a styrene butadiene copolymer, a polyurethane resin, a polyester resin, an amino resin, and synthetic rubber.

Examples of thermosetting resin include a phenol resin, an epoxy resin, a polyurethane curable resin, a urea resin, a melamine resin, an alkyd resin, a silicone resin, a polyamine resin, and a urea formaldehyde resin.

For the purpose of improving the dispersibility of the magnetic powder, a polar functional group such as —SO₃M, —OSO₃M, —COOM, P═O(OM)₂ (where M represents a hydrogen atom or an alkali metal such as lithium, potassium, and sodium), a side chain amine having a terminal group represented by —NR1R2 or —NR1R2R3⁺X⁻, a main chain amine represented by >NR1R2⁺X⁻ (where R1, R2, and R3 each represent a hydrogen atom or a hydrocarbon group, and X⁻ represents a halogen element ion such as fluorine, chlorine, bromine, and iodine, an inorganic ion, or an organic ion), —OH, —SH, —CN, and an epoxy group may be introduced into all of the binders described above. The amount of these polar functional groups to be introduced into the binder is favorably 10⁻¹ to 10⁻⁸ mol/g, more favorably 10⁻² to 10⁻⁶ mol/g.

(Lubricant)

Examples of the lubricant include esters of monobasic fatty acids having 10 to 24 carbon atoms and one of monovalent to hexavalent alcohols having 2 to 12 carbon atoms, mixed esters thereof, a difatty acid ester, and a trifatty acid ester. Specific examples of the lubricant include lauric acid, myristic acid, palmitic acid, stearic acid, behenic acid, oleic acid, linoleic acid, linolenic acid, elaidic acid, butyl stearate, pentyl stearate, heptyl stearate, octyl stearate, isooctyl stearate, and octyl myristate.

(Antistatic Agent)

Examples of the antistatic agent include carbon black, a natural surfactant, a nonionic surfactant, and a cationic surfactant.

(Abrasive)

Examples of the abrasive include α-alumina having an a transformation rate of 90% or more, β-alumina, γ-alumina, silicon carbide, chromium oxide, cerium oxide, α-iron oxide, corundum, silicon nitride, titanium carbide, titanium oxide, silicon dioxide, tin oxide, magnesium oxide, tungsten oxide, zirconium oxide, boron nitride, zinc oxide, calcium carbonate, calcium sulfate, barium sulfate, molybdenum disulfide, acicular α-iron oxide obtained by dehydrating and annealing a raw material of magnetic iron oxide, and those obtained by performing surface treatment thereon with aluminum and/or silica as necessary.

(Curing Agent)

Examples of the curing agent include polyisocyanate. Examples of the polyisocyanate include aromatic polyisocyanate such as an adduct of tolylene diisocyanate (TDI) and an active hydrogen compound and aliphatic polyisocyanate such as an adduct of hexamethylene diisocyanate (HMDI) and an active hydrogen compound. The weight average molecular weight of these polyisocyanates is desirably in the range of 100 to 3000.

(Rust Inhibitor)

Examples of the rust inhibitor include phenols, naphthols, quinones, heterocyclic compounds containing a nitrogen atom, heterocyclic compounds containing an oxygen atom, and heterocyclic compounds containing a sulfur atom.

(Non-Magnetic Reinforcing Particle)

Examples of the non-magnetic reinforcing particle include aluminum oxide (α-, β-, or γ-alumina), chromium oxide, silicon oxide, diamond, garnet, emery, boron nitride, titanium carbide, silicon carbide, titanium carbide, and titanium oxide (rutile or anatase titanium oxide).

(Underlayer)

The underlayer 12 is for alleviating the unevenness of the surface of the base 11 and adjusting the unevenness of the surface of the magnetic layer 13. The underlayer 12 may include a lubricant to provide the lubricant to the surface of the magnetic layer 13. The underlayer 12 is a non-magnetic layer including a non-magnetic powder and a binder. The underlayer 12 may further include at least one additive of a lubricant, an antistatic agent, a curing agent, or a rust inhibitor.

The average thickness of the underlayer 12 is favorably 0.6 μm or more and 2.0 μm or less, more favorably 0.8 μm or more and 1.4 μm or less. Note that the average thickness of the underlayer 12 is obtained in a manner similar to that for the average thickness of the magnetic layer 13. However, the magnification of the TEM image is appropriately adjusted in accordance with the thickness of the underlayer 12.

(Non-Magnetic Powder)

The non-magnetic powder includes, for example, at least one of an inorganic particle powder or an organic particle powder. Further, the non-magnetic powder may include a carbon powder such as carbon black. Note that one kind of non-magnetic powder may be used alone, or two or more kinds of non-magnetic powders may be used in combination. The inorganic particles include, for example, a metal, a metal oxide, a metal carbonate, a metal sulfate, a metal nitride, a metal carbide, or a metal sulfide. Examples of the shape of the non-magnetic powder include various shapes such as a needle shape, a spherical shape, a cubic shape, and a plate shape, but are not limited to these shapes.

(Binder)

The binder is similar to that in the magnetic layer 13 described above.

(Additive)

The lubricant, the antistatic agent, the curing agent, and the rust inhibitor are similar to those in the magnetic layer 13 described above.

(Back Layer)

The back layer 14 includes a binder and a non-magnetic powder. The back layer 14 may further include at least one additive of a lubricant, a curing agent, or an antistatic agent, as necessary. The lubricant and the antistatic agent are similar to those in the magnetic layer 13 described above. Further, the non-magnetic powder is similar to that in the underlayer 12 described above.

The average particle size of the non-magnetic powder is favorably 10 nm or more and 150 nm or less, more favorably 15 nm or more and 110 nm or less. The average particle size of the non-magnetic powder is obtained in a manner similar to that for the average particle size of the magnetic powder described above. The non-magnetic powder may include a non-magnetic powder having two or more particle size distributions.

The upper limit value of the average thickness of the back layer 14 is favorably 0.6 μm or less. When the upper limit value of the average thickness of the back layer 14 is 0.6 μm or less, since the thickness of the underlayer 12 or the base 11 can be kept thick even in the case where the average thickness of the magnetic recording medium 10 is 5.6 μm or less, it is possible to maintain the traveling stability of the magnetic recording medium 10 in the recording/reproduction apparatus. The lower limit value of the average thickness of the back layer 14 is not particularly limited, but is, for example, 0.2 μm or more.

The average thickness of the back layer 14 is obtained as follows. First, the magnetic recording medium 10 having a ½-inch width is prepared and cut into the length of 250 mm to prepare a sample. Next, the thickness of the sample is measured at positions of five or more points using a laser hologage manufactured by Mitutoyo as a measuring apparatus, and the measured values are simply averaged (arithmetically averaged) to calculate an average thickness T [μm] of the magnetic recording medium 10. Note that the measurement positions are randomly selected from the sample. Subsequently, the back layer 14 of the sample is removed with a solvent such as MEK (methyl ethyl ketone) and dilute hydrochloric acid. After that, the thickness of the sample is measured at positions of five or more points using the above-mentioned laser hologage again, and the measured values are simply averaged (arithmetically averaged) to calculate an average thickness t₁ [μm] of the magnetic recording medium 10 from which the back layer 14 has been removed. Note that the measurement positions are randomly selected from the sample. After that, the average thickness t [μm] of the back layer 14 is obtained by the following formula.

t[μm]=T[μm]−T₁[μm]

(Average Thickness of Magnetic Recording Medium)

The upper limit value of the average thickness (average total thickness) of the magnetic recording medium 10 is favorably 5.6 μm or less, more favorably 5.0 μm or less, and still more favorably 4.4 μm or less. When the average thickness of the magnetic recording medium 10 is 5.6 μm or less, the recording capacity in one data cartridge can be made higher than that of a typical magnetic recording medium. The lower limit value of the average thickness of the magnetic recording medium 10 is not particularly limited, but is, for example, 3.5 μm or more.

The average thickness of the magnetic recording medium 10 is obtained by the procedure described in the above-mentioned method of measuring the average thickness of the back layer 14.

(Total Thickness of Magnetic Layer and Underlayer)

The total sum of the average thicknesses of the magnetic layer 13 and the underlayer 12 is favorably 1.1 μm or less, more favorably 0.8 μm or less, and still more favorably 0.6 μm or less. When the total thickness of the average thicknesses of the magnetic layer 13 and the underlayer 12 is 1.1 μm or less, the ratio of the magnetic layer 13 included per unit volume increases, making it possible to improve the volume capacity. The lower limit value of the total thickness of the average thicknesses of the magnetic layer 13 and the underlayer 12 is favorably 0.3 μm or more from the viewpoint of supplying the lubricant from the underlayer 12. The method of measuring the average thickness of each of the underlayer 12 and the magnetic layer 13 is as described above.

(Coercive Force Hc)

The coercive force Hc of the magnetic recording medium 10 in the perpendicular direction (direction of the orientation of the magnetic powder) is favorably 2500 Oe or more and 4500 Oe or less, more favorably 2500 Oe or more and 4000 Oe or less, still more favorably 2500 Oe or more and 3500 Oe or less, and particularly favorably 2500 Oe or more and 3000 Oe or less. When the coercive force Hc is 2500 Oe or more, it is possible to suppress the reduction of the electromagnetic conversion characteristics in a high-temperature environment due to the effect of thermal disturbance and the effect of the demagnetizing field. Meanwhile, when the coercive force Hc is 4500 Oe or less, it is possible to suppress the generation of portions where recording cannot be performed due to the difficulty of saturation recording in the recording head. Therefore, the noise is suppressed from increasing, and it is possible to suppress the reduction of the electromagnetic conversion characteristics as a result.

The coercive force Hc is obtained as follows. First, a measurement sample is cut from the elongated magnetic recording medium 10, and the M-H loop of the entire measurement sample is measured in the perpendicular direction (thickness direction) of the measurement sample using the VSM. Next, the coating film (the underlayer 12, the magnetic layer 13, the back layer 14, and the like) is wiped off using acetone, ethanol, or the like, only the base 11 is left as a sample for background correction, and the M-H loop of the base 11 is measured in the perpendicular direction (thickness direction) of the base 11 using the VSM. After that, the M-H loop of the base 11 is subtracted from the M-H loop of the entire measurement sample to obtain the M-H loop after background correction. The coercive force Hc is obtained from the obtained M-H loop. Note that the measurement of the M-H loops described above is performed at 25° C. Further, the “demagnetizing field correction ” is not performed when the M-H loop is measured in the perpendicular direction of the magnetic recording medium 10.

(Squareness ratio)

A squareness ratio S₁ of the magnetic recording medium 10 in the perpendicular direction (thickness direction) is 65% or more, favorably 70% or more, and more favorably 75% or more. When the squareness ratio S₁ is 65% or more, since the perpendicular orientation of the magnetic powder is sufficiently high, it is possible to achieve excellent electromagnetic conversion characteristics.

The squareness ratio S₁ is obtained as follows. First, the M-H loop after background correction is obtained in a manner similar to the above-mentioned method of measuring the coercive force Hc. Next, a saturation magnetization Ms (emu) and a residual magnetization Mr (emu) of the obtained M-H loop are substituted into the following formula to calculate the squareness ratio S₁ (%).

Squareness ratio S₁(%)=(Mr/Ms)×100

A squareness ratio S₂ of the magnetic recording medium 10 in the longitudinal direction (traveling direction) is favorably 35% or less, more favorably 30% or less, and still more favorably 25% or less. When the squareness ratio S₂ is 35% or less, since the perpendicular orientation of the magnetic power is sufficiently high, it is possible to achieve excellent electromagnetic conversion characteristics.

The squareness ratio S₂ is obtained in a manner similar to that for the squareness ratio S₁ except that the M-H loop is measured in the longitudinal direction (traveling direction) of the magnetic recording medium 10 and the base 11.

(Ratio L4/L2)

The ratio L4/L2 of a component L4 having a multiaxial crystal magnetic anisotropy to a component

L2 having a uniaxial crystal magnetic anisotropy represents the strength of the uniaxial crystal magnetic anisotropy of the magnetic powder, the components being obtained by applying Fourier transformation to a torque waveform of the magnetic recording medium 10. The smaller the ratio L4/L2, the stronger the uniaxial crystal magnetic anisotropy of the magnetic powder. This ratio L4/L2 is 0 or more and 0.25 or less, favorably 0 or more and 0.20 or less, and more favorably 0 or more and 0.18 or less. When the ratio L4/L2 is 0 or more and 0.25 or less, since the uniaxial crystal magnetic anisotropy of the magnetic powder is sufficiently strong, it is possible to reduce noises. Therefore, it is possible to improve the electromagnetic conversion characteristics.

The above-mentioned ratio L4/L2 is obtained as follows.

(1) First, three pieces of the magnetic recording medium 10 are cut to have predetermined sizes, the three pieces are superposed and attached, and then both surfaces are attached with a mending tape to obtain a laminate. The obtained laminate is punched with a round punch having a diameter p=6.25 to obtain a sample having a circular shape.

(2) Next, the obtained sample is AC demagnetized. This processing is performed considering that in the case of using a sample in a magnetized state, the magnetization is saturated when an external magnetic field is applied, and there is a possibility that the output numerical value of the torque is not normal.

(3) Next, the sample is set to a measuring apparatus. Specifically, in the case where the magnetic powder is perpendicularly oriented, the sample is set perpendicularly to the direction of the applied magnetic field. Meanwhile, in the case where the magnetic powder is longitudinally oriented, the sample is set horizontally to the direction of the applied magnetic field.

(4) Next, zero magnetic field adjustment is performed on a measuring apparatus (manufactured by Toei Industry Co., Ltd., TRT-2 type), and then an external magnetic field of 15000 [Oe] is applied in the torque angle measurement mode to measure the torque waveform.

(5) After the measurement, the ratio L4/L2 is obtained by using the component L2 having a uniaxial crystal magnetic anisotropy and the component L4 having a multiaxial crystal magnetic anisotropy, the components being calculated and displayed after being applied with Fourier transformation automatically by the measuring apparatus.

(Thermal Stability Δ)

A thermal stability Δ(=KᵤV_{act}/k_{B}T, Kᵤ: a magnetocrystalline anisotropy constant of magnetic powder, V_{act}: an activation volume of the magnetic powder, k_{B}: a Boltzmann constant, T: an absolute temperature) of the magnetic recording medium 10 is favorably 60 or more, more favorably 80 or more, and still more favorably 85 or more. When the thermal stability Δ is 60 or more, it is possible to suppress the decrease in the thermal stability. Therefore, it is possible to suppress the degradation of the output signal of the magnetic recording medium 10.

The thermal stability Δ is calculated using the Sharrock equation shown below (Reference: IEEE TRANSACTIONS ON MAGNETICS, VOL. 50, NO. 11, November 2014, J. Flanders and M. P. Sharrock: J. Appl. Phys., 62, 2918 (1987)).

Hᵣ(t′)=H₀[1−{k_{B}T/(KᵤV_{act})ln(f₀t′/0.693)}ⁿ]

(However, Hᵣ: residual magnetic field, t′: magnetization attenuation, H₀: magnetic field change amount, k_{B}: Boltzmann constant,

T: an absolute temperature, Kᵤ: a magnetocrystalline anisotropy constant, V_{act}: an activation volume, f₀: a frequency factor, n: a coefficient)

Note that the (a) residual magnetic field Hᵣ, (b) magnetization attenuation t′, and (c)magnetic field change amount H₀ are obtained as follows. Further, the following numerical values are used as the (d) frequency factor f₀ and (e) coefficient n.

The (a) residual magnetic field Hᵣ is obtained in the DCD measurement mode of pulse VSM and normal VSM.

The (b) magnetization attenuation t′ is obtained as follows. That is, external magnetic fields close to the coercive force Hc of the magnetic recording medium 10 are applied under three conditions, and the magnetization attenuation is measured by normal VSM. Then, the magnetization attenuation t′ is calculated using the Flanders equation from the magnetization attenuation.

Here, the “coercive force Hc” means the coercive force Hc in the orientation direction of the magnetic powder. That is, in the case where the magnetic powder is oriented in the perpendicular direction, the “coercive force Hc” means the coercive force Hc in the perpendicular direction. Meanwhile, in the case where the magnetic powder is oriented in the longitudinal direction, the “coercive force Hc” means the coercive force Hc in the longitudinal direction.

Further, the “external magnetic fields under three conditions” mean a magnetic field equal to or higher than the coercive force Hc (magnetic field in which a positive magnetization is obtained), a magnetic field close to the coercive force Hc (magnetic field in which a magnetization close to zero is obtained), and a magnetic field below the coercive force Hc (magnetic field in which a negative magnetization is obtained). For example, in the case of measuring the magnetization attenuation t′ of an Example 1 (the coercive force Hc=2870 Oe in the perpendicular direction) described below, the external magnetic fields under three conditions are set to 3200 Oe, 2800 Oe, and 2400 Oe.

The (c) magnetic field change amount H₀ is a constant that appears when calculating the magnetization attenuation t′.

The (d) frequency factor f₀ is a constant value, and f₀=5.0×109 Hz.

The (e) coefficient n is set to a value corresponding to the magnetocrystalline anisotropy of the cobalt ferrite particles. In the case where the cobalt ferrite particles have a uniaxial crystal magnetic anisotropy, n is set to 0.5. Meanwhile, in the case where the cobalt ferrite particles have a multiaxial crystal magnetic anisotropy (triaxial magnetocrystalline anisotropy), n is set to 0.77.

(Magnetocrystalline Anisotropy Constant Kᵤ and Activation Volume V_{act})

The magnetocrystalline anisotropy constant Kᵤ of the magnetic recording medium 10 is favorably 0.1 Merg/cm³ or more and 1.5 Merg/cm³, more favorably 0.3 Merg/cm³ or more and 1.5 Merg/cm³ or less, and still more favorably 0.6 Merg/cm³ or more and 1.5 Merg/cm³ or less. When the magnetocrystalline anisotropy constant Kᵤ is less than 0.1 Merg/cm³, the necessary thermal stability Δ cannot be ensured. Meanwhile, when the magnetocrystalline anisotropy constant Kᵤ exceeds 1.5 Merg/cm³, the writability of the magnetic head cannot be ensured.

When the activation volume V_{act} of the magnetic powder of the magnetic recording medium 10 is 16000 [nm³] or less, more favorably 15000 [nm³]. When the activation volume V_{act} is 16000 nm³ or less, since the dispersion state of the magnetic powder is improved, the bit-inversion region can be reduced, and it is possible to suppress the degradation of the magnetization signal recorded in an adjacent track due to the leakage magnetic field from the recording head. Therefore, it is possible to achieve excellent electromagnetic conversion characteristics.

The magnetocrystalline anisotropy constant Kᵤ and the activation volume V_{act} are obtained as follows.

The thermal stability Δ is calculated by the Sharrock equation as described above, and then the magnetocrystalline anisotropy constant Kᵤ and the activation volume V_{act} are obtained. Specifically, they are obtained as follows. Note that the sampling and the measurement method are similar to those in the method of calculating the ratio L4/L2 described above. First, the thermal stability Δ is calculated by the Sharrock equation as described above. Next, in the torque angle measurement mode, external magnetic fields of 10000, 12500, and 15000 Oe are applied as the applied magnetic field to calculate the magnetocrystalline anisotropy constant Kᵤ using a saturation extrapolation method. At this time, the magnetocrystalline anisotropy constant Kᵤ is calculated by the sum of Kᵤ₁ and Kᵤ₂ in the case of perpendicular orientation and calculated only by Kᵤ₁ in the case of longitudinal orientation. After that, the calculated magnetocrystalline anisotropy constant Kᵤ and the absolute temperature T=300K (room temperature) are substituted into the Sharrock equation to obtain the activation volume V_{act}.

[2 Method of Producing Magnetic Powder]

Next, the method of producing the magnetic powder used for the magnetic layer 13 will be described. This method of producing the magnetic powder includes preparing a cobalt ferrite magnetic powder using a component for forming glass and a component for forming a cobalt ferrite magnetic powder (hereinafter, referred to simply as the “component for forming a magnetic powder”) by a glass crystallization method.

(Step of Mixing Raw Materials)

First, the component for forming glass and the component for forming a magnetic powder are mixed to obtain a mixture.

The component for forming glass contains sodium borate (Na₂B₄O₇). When the component for forming glass contains sodium borate, the component for forming a magnetic powder can be dissolved in glass in the step of melting and amorphization described below. Further, quenching conditions for vitrification in the step of melting and amorphization described below are relaxed. As a result, the amorphous body can be obtained also by placing the melt into water to quench the melt instead of quenching the melt using a twin-roll quenching apparatus. Further, in the step of taking out the magnetic powder described below, the crystallized glass (non-magnetic component) is removed by hot water or the like, and the magnetic powder can be taken out.

The ratio of sodium borate to the total amount of the component for forming glass and the component for forming a magnetic powder is favorably 35 mol % or more and 60 mol % or less. When the ratio of sodium borate is 35 mol % or more, it is possible to obtain an amorphous body having high homogeneity. Meanwhile, when the ratio of sodium borate is 60 mol % or less, it is possible to suppress the reduction in the amount of the magnetic powder to be obtained.

It is favorable that the component for forming glass further includes at least one of an oxide of an alkaline earth metal or a precursor of the oxide. In the case where the component for forming glass further includes at least one of an oxide of an alkaline earth metal or a precursor of the oxide, the glass softening point of the glass can be increased, and the component for forming a magnetic powder can be crystallized at a temperature near the glass softening point. Therefore, it is possible to suppress the glass from being softened and the precipitated magnetic powder from being sintered at the time point when reaching the temperature at which the component for forming a magnetic powder is crystallized.

The oxide of an alkaline earth metal includes, for example, at least one of calcium oxide (CaO), strontium oxide (SrO), or barium oxide (BaO), and includes, particularly favorably, at least one of strontium oxide or barium oxide of these oxides. This is because the effect of increasing the glass softening point by strontium oxide or barium oxide is higher than that of increasing the glass softening point by calcium oxide. Note that in the case where calcium oxide is used as the oxide of an alkaline earth metal, it is favorable to use calcium oxide in combination with at least one of strontium oxide or barium oxide from the viewpoint of increasing the glass softening point.

As the precursor of an oxide of an alkaline earth metal, a material that generates an oxide of an alkaline earth metal by heating at the time of melting in the step of melting and amorphization described below is favorable. Examples of such a material include, but are not limited to, a carbonate of an alkaline earth metal. The carbonate of an alkaline earth metal includes, for example, at least one of calcium carbonate (CaCO₃), strontium carbonate (SrCO₃), or barium carbonate (BaCO₃), and includes, particularly favorably, at least one of strontium carbonate or barium carbonate of these oxides. Since the oxide of an alkaline earth metal is unstable by being combined with CO₂ or moisture in air, it is possible to perform accurate measurement by using, as the component for forming glass, a precursor of an oxide of an alkaline earth metal (e.g., a carbonate of an alkaline earth metal) rather than an oxide of an alkaline earth metal.

The molar ratio of the oxide of an alkaline earth metal to sodium borate (oxide of an alkaline earth metal/sodium borate) is favorably 0.25 or more and 0.5 or less. When the above-mentioned molar ratio is less than 0.25, the glass softening point of the glass becomes low, and there is a possibility that the glass is softened before enough crystallinity is imparted to the magnetic powder in the step of crystallization described below. Therefore, there is a possibility that the precipitated magnetic powder is sintered to increase the particle size of the magnetic powder. Meanwhile, when the above-mentioned molar ratio exceeds 0.5, the glass softening point of the glass becomes too high, a hexagonal ferrite magnetic powder precipitates with a cobalt ferrite magnetic powder, and there is a possibility that the variation of the coercive force Hc of the magnetic powder becomes large. Therefore, there is a possibility that in the case where the magnetic powder is applied to the magnetic recording medium 10, S/N is reduced.

The component for forming a magnetic powder includes at least one of cobalt oxide (CoO) or a precursor of cobalt oxide and iron oxide (Fe₂O₃). As the precursor of cobalt oxide, a material that generates cobalt oxide by heating at the time of melting in the step of melting and amorphization described below is favorable. Examples of such a material include, but are not limited to, cobalt carbonate (CoCO₃).

The component for forming a magnetic powder may include, as necessary, at least one selected from the group consisting of an oxide of a transition metal element other than Co and Fe, a precursor of an oxide of a transition metal element other than Co and Fe, zinc oxide, a precursor of zinc oxide, germanium oxide, and a precursor of germanium oxide.

The oxide of a transition metal element other than Co and Fe includes, for example, at least one selected from the group consisting of manganese oxide (e.g., MnO), nickel oxide (e.g., NiO₂), copper oxide (e.g., Cu₂O), tantalum oxide (e.g., Ta₂O₅), and zirconium oxide (e.g., ZrO₂)

As the precursor of an oxide of a transition metal element other than Co and Fe, a material that generates an oxide of a transition metal element other than Co and Fe by heating at the time of melting in the step of melting and amorphization described below is favorable. Examples of such a material include, but are not limited to, a carbonate of a transition metal element other than Co and Fe. The carbonate of a transition metal element other than Co and Fe includes, for example, at least one selected from the group consisting of manganese carbonate, nickel carbonate, copper carbonate, tantalum carbonate, and zirconium carbonate.

As the precursor of zinc oxide, a material that generates zinc oxide by heating at the time of melting in the step of melting and amorphization described below is favorable. Examples of such a material include zinc carbonate. As the precursor of germanium oxide, a material that generates germanium oxide by heating at the time of melting in the step of melting and amorphization described below is favorable. Examples of such a material include germanium carbonate.

(Step of Melting and Amorphization)

Next, the obtained mixture is heated at a high temperature (e.g., approximately 1400° C.) and melted to obtain a melt, and then the melt is quenched to obtain an amorphous body (glass body). Here, even if a microcrystalline material is partially precipitated, there is no problem as long as it does not become coarse at the time of heat treatment to be performed later.

As a method of quenching the melt, for example, a liquid quenching method such as a metal twin-roll method and a single-roll method, or a method of charging the melt into water can be used, but the method of charging the melt into water is favorable from the viewpoint of simplifying a manufacturing facility.

(Step of Crystallization)

Subsequently, by performing heat treatment on the amorphous body with a heating apparatus to crystallize the amorphous body, a cobalt ferrite magnetic powder is precipitated in the crystallized glass to obtain a magnetic powder-containing material. At this time, since the magnetic powder is precipitated in the crystallized glass (non-magnetic component), it is possible to prevent the particles from being sintered with each other and obtain a magnetic powder of fine particle sizes. Further, since heat treatment is performed on the amorphous body at a high temperature, it is possible to obtain a magnetic powder having favorable crystallinity and a high magnetization (σs).

The heat treatment is performed in an atmosphere with an oxygen concentration lower than that of the atmospheric atmosphere. By performing the heat treatment in such an atmosphere, it is possible to improve the coercive force Hc of the magnetic powder and impart a uniaxial crystal magnetic anisotropy to the magnetic powder. The oxygen partial pressure during the heat treatment is 1.0 kPa or less, favorably 0.9 kPa or less, more favorably 0.5 kPa or less, and still more favorably 0.1 kPa or less. Note that the oxygen partial pressure of the atmospheric atmosphere is 21 kPa. When the oxygen partial pressure during the heat treatment is 1.0 kPa or less, the coercive force Hc of the magnetic powder can be made 2500 Oe or more. In order to make the oxygen concentration of the atmosphere during the heat treatment lower than that in the atmospheric atmosphere, nitrogen or an inert gas such as an Ar gas may be introduced into a heating apparatus housing the amorphous body, or the inside of the heating apparatus may be evacuated to be in a low-pressure state using a vacuum pump.

The temperature of the heat treatment is favorably 500° C. or more and 670° C. or less, more favorably 530° C. or more and 650° C. or less, e.g., approximately 610° C. The time of the heat treatment is favorably 0.5 hours or more and 20 hours or less, more favorably 1.0 hour or more and 10 hours or less.

It is favorable that the glass softening point of the glass that is a non-magnetic component and the crystallization temperature of the component for forming a magnetic powder are close to each other. When the glass softening point is low and the glass softening point and the crystallization temperature are apart from each other, the glass softens at the time point when reaching the temperature for crystallizing the component for forming a magnetic powder, and there is a possibility that the precipitated magnetic powder is easily sintered and the size of the magnetic powder becomes large.

(Step of taking out magnetic powder)

After that, for example, the crystallized glass that is a non-magnetic component is removed by weak acid or hot water to take out the magnetic powder. As a result, the target magnetic powder is obtained.

[3 Method of Producing Magnetic Recording Medium]

Next, the method of producing the magnetic recording medium 10 having the above-mentioned configuration will be described. First, a coating material for forming an underlayer is prepared by kneading and dispersing a non-magnetic powder, a binder, and the like in a solvent. Next, a coating material for forming a magnetic layer is prepared by kneading and dispersing a magnetic powder, a binder, and the like in a solvent. For preparing the coating material for forming a magnetic layer and the coating material for forming an underlayer, for example, the following solvents, dispersing apparatus, and kneading apparatus can be used.

Examples of the solvent used for preparing coating materials include a ketone solvent such as acetone, methyl ethyl ketone, methyl isobutyl ketone, and cyclohexanone, an alcohol solvent such as methanol, ethanol, and propanol, an ester solvent such as methyl acetate, ethyl acetate, butyl acetate, propyl acetate, ethyl lactate, and ethylene glycol acetate, an ether solvent such as diethylene glycol dimethyl ether, 2-ethoxyethanol, tetrahydrofuran, and dioxane, an aromatic hydrocarbon solvent such as benzene, toluene, and xylene, and a halogenated hydrocarbon solvent such as methylene chloride, ethylene chloride, carbon tetrachloride, chloroform, and chlorobenzene. These may be used alone or may be appropriately mixed and used.

As the above-mentioned kneading apparatus used for the preparation of the coating materials, for example, a kneading apparatus such as a continuous twin-screw kneader, a continuous twin-screw kneader capable of diluting in multiple stages, a kneader, a pressure kneader, and a roll kneader can be used. However, the present disclosure is not particularly limited to these apparatuses. Further, as the above-mentioned dispersing apparatus used for the preparation of the coating materials, for example, a dispersing apparatus such as a roll mill, a ball mill, a horizontal sand mil, a perpendicular sand mil, a spike mill, a pin mill, a tower mill, a pearl mill (e.g., “DCP mill” manufactured by Eirich Co., Ltd.), a homogenizer, and an ultrasonic disperser can be used. However, the present disclosure is not particularly limited to these apparatuses.

Next, the coating material for forming an underlayer is applied to one main surface of the base 11 and dried to form the underlayer 12. Subsequently, the coating material for forming a magnetic layer is applied onto this underlayer 12 and dried to form the magnetic layer 13 on the underlayer 12. Note that during drying, the magnetic field of the magnetic powder is oriented in the thickness direction of the base 11 by, for example, a solenoid coil. Further, during drying, the magnetic field of the magnetic powder may be oriented in the traveling direction (longitudinal direction) of the base 11 by, for example, a solenoid coil, and then the magnetic field may be oriented in the thickness direction of the base 11. After forming the magnetic layer 13, the back layer 14 is formed on the other main surface of the base 11. In this way, the magnetic recording medium 10 is obtained.

After that, the obtained magnetic recording medium 10 is wound into a large diameter core, and curing treatment is performed. Finally, calendering is performed on the magnetic recording medium 10, and then the magnetic recording medium 10 is cut into a predetermined width (e.g., ½-inch width). In this way, the target elongated magnetic recording medium 10 can be obtained.

[4 Effects]

As described above, in the magnetic recording medium 10 according to the first embodiment, the ratio L4/L2 of the component L2 having a uniaxial crystal magnetic anisotropy and the component L4 having a multiaxial crystal magnetic anisotropy is 0 or more and 0.25 or less, the components being obtained by applying Fourier transformation to a torque waveform of the magnetic recording medium. When the ratio L4/L2 is 0 or more and 0.25 or less, since the uniaxial crystal magnetic anisotropy of the magnetic powder (magnetic layer) can be made stronger, noises can be reduced. Therefore, it is possible to improve the electromagnetic conversion characteristics.

### EXAMPLE

Hereinafter, the present disclosure will be specifically described by way of Examples. However, the present disclosure is not limited to only these Examples.

In this Example, the average thickness of the base film (base), the average thickness of the magnetic layer, the average thickness of the underlayer, the average thickness of the back layer, and the average thickness of the magnetic tape (magnetic recording medium) are obtained by the measurement method described in the above-mentioned embodiment.

### Example 1

(Step of Mixing Raw Materials)

First, sodium tetraborate (Na₂B₄O₇) and strontium carbonate (SrCO₃) as the component for forming glass and iron oxide (Fe₂O₃), basic cobalt carbonate (2CoCO₃.3Co(OH)₂), and copper oxide (Cu₂O) as the component for forming a magnetic powder were prepared. Then, the prepared raw materials were mixed so that the molar ratio of Na₂B₄O₇:SrCO₃:Fe₂O₃:2CoCO₃.3Co(OH)₂:Cu₂O became 51.7:20.7:22.34:2.92:2.34 to obtain a mixture.

(Step of Melting and Amorphization)

Next, the obtained mixture was heated at 1400° C. for 1 hour to be melt to obtain a melt, and then the melt was charged into water to obtain an amorphous body (glass body). Note that during the above-mentioned heating, carbonic acid is removed from strontium carbonate to generate strontium oxide. Further, carbonic acid is removed from basic cobalt carbonate to generate cobalt oxide.

(Step of Crystallization)

Subsequently, heat treatment was performed on the obtained amorphous body at 610° C. in an atmosphere of oxygen partial pressure of 0.1 kPa for 2.5 hours to crystallize the amorphous body, thereby precipitating a cobalt ferrite magnetic powder. As a result, a magnetic powder-containing material in which cobalt ferrite was precipitated in the crystallized glass was obtained.

(Step of Taking Out Magnetic Powder)

After that, the crystallized glass that was a non-magnetic component was removed by hot water to take out a cobalt ferrite magnetic powder (having a composition of (Co_{0.7}Cu_{0.3})_{0.7}Fe₂O₄, a substantially cubic shape, and an average particle size of 23.1 nm).

(Analysis by X-Ray Diffraction)

The cobalt ferrite magnetic powder obtained as described above was analyzed by X-ray diffraction. As a result, a peak of cobalt ferrite was observed, whereas a peak of hexagonal ferrite or a non-magnetic component (crystallized glass) was not observed. Thus, it has been found that precipitation of a hexagonal ferrite magnetic powder can be suppressed in the above-mentioned step of crystallization and the crystallized glass can be removed by hot water in the above-mentioned step of taking out a magnetic powder.

(Step of Preparing Coating Material for Forming a Magnetic Layer)

A coating material for forming a magnetic layer was prepared as follows. First, a first composition of the following formulation was kneaded with an extruder. Next, the kneaded first composition and a second composition of the following formulation were added to a stirring tank including a dispersion apparatus to perform premixing. Subsequently, sand mill mixing was further performed, and filter treatment was performed to prepare a coating material for forming a magnetic layer.

(First Composition)

Cobalt ferrite magnetic powder: 100 parts by mass

Vinyl chloride resin (30% by mass of cyclohexanone solution): 10 parts by mass

(degree of polymerization of 300, Mn=10000, containing OSO₃K=0.07 mmol/g and secondary OH=0.3 mmol/g as polar groups)

Aluminum oxide powder: 5 parts by mass

(α-Al₂O₃, average particle size of 0.2 μm)

Carbon black: 2 parts by mass

(manufactured by Tokai Carbon Co., Ltd., trade name: Seast TA)

Note that as the magnetic powder, a cobalt ferrite magnetic powder obtained as described above was used.

(Second Composition)

Vinyl chloride resin: 1.1 parts by mass

(resin solution: 30% by mass of resin content, 70% by mass of cyclohexanone)

n-butyl stearate:2 parts by mass

Methyl ethyl ketone: 121.3 parts by mass

Toluene: 121.3 parts by mass

Cyclohexanone: 60.7 parts by mass

Finally, 4 parts by mass of polyisocyanate (trade name: Coronate L, manufactured by Nippon Polyurethane Co., Ltd.) and 2 parts by mass of myristic acid were added as a curing agent to the coating material for forming a magnetic layer prepared as described above.

(Step of Preparing Coating Material for Forming an Underlayer)

A coating material for forming an underlayer was prepared as follows. First, a third composition of the following formulation was kneaded with an extruder. Next, the kneaded third composition and a fourth composition of the following formulation were added to a stirring tank including a dispersion apparatus to perform premixing. Subsequently, sand mill mixing was further performed, and filter treatment was performed to prepare a coating material for forming an underlayer.

(Third Composition)

Acicular iron oxide powder: 100 parts by mass

(α-Fe₂O₃, average major axis length of 0.15 μm)

Vinyl chloride resin: 55.6 parts by mass (resin solution: 30% by mass of resin content, 70% by mass of cyclohexanone)

Carbon black: 10 parts by mass

(average particle size of 20 nm)

(Fourth Composition)

Polyurethane resin UR8200 (manufactured by TOYOBO CO., LTD.): 18.5 parts by mass

n-butyl stearate: 2 parts by mass

Methyl ethyl ketone: 108.2 parts by mass

Toluene: 108.2 parts by mass

Cyclohexanone: 18.5 parts by mass

Finally, 4 parts by mass of polyisocyanate (trade name: Coronate L, manufactured by Nippon Polyurethane Co., Ltd.) and 2 parts by mass of myristic acid were added as a curing agent to the coating material for forming an underlayer prepared as described above.

(Step of Preparing Coating Material for Forming a Back Layer)

A coating material for forming a back layer was prepared as follows. A coating material for forming a back layer was prepared by mixing the following raw materials in a stirring tank including a dispersion apparatus and performing filter treatment thereon.

Carbon black (manufactured by ASAHI CARBON CO., LTD., trade name: #80):100 parts by mass

polyester(s)polyurethane:100 parts by mass

(manufactured by Nippon Polyurethane Co., Ltd., trade name: N-2304)

Methyl ethyl ketone: 500 parts by mass

Toluene: 400 parts by mass

Cyclohexanone: 100 parts by mass

(Step of Deposition)

A magnetic tape was prepared as follows using the coating material prepared as described above. First, as a support, a PEN film (base film) having a long shape and an average thickness of 4.0 μm was prepared. Next, the coating material for forming an underlayer was applied onto one main surface of the PEN film and dried to from an underlayer having an average thickness of 1.015 μm. Next, the coating material for forming a magnetic layer was applied onto the underlayer and dried to form a magnetic layer having an average thickness of 85 nm on the underlayer. Note that during the drying of the coating material for forming a magnetic layer, the magnetic field of the magnetic powder was oriented in the thickness direction of the PEN film by a solenoid coil.

Subsequently, the coating material for forming a back layer was applied onto the other main surface of the PEN film and dried to form a back layer having an average thickness of 0.4 μm. Then, curing treatment was performed on the PEN film on which the underlayer, the magnetic layer, and the back layer were formed. After that, calendering was performed thereon to smooth the surface of the magnetic layer.

(Step of Cutting)

The magnetic tape obtained as described above was cut into ½-inch (12.65 mm) wide. As a result, a magnetic tape having a long shape and an average thickness of 5.5 μm was obtained.

### Example 2

In the step of preparing a magnetic powder, sodium tetraborate (Na₂B₄O₇) and strontium carbonate (SrCO₃) as the component for forming glass and iron oxide (Fe₂O₃) and basic cobalt carbonate (2CoCO₃.3Co(OH)₂) as the component for forming a magnetic powder were prepared. Then, the prepared raw materials were mixed so that the molar ratio of Na₂B₄O₇:SrCO₃:Fe₂O₃:2CoCO₃.3Co (OH)₂ is 54.3:19.0:23.0:3.7 to obtain a mixture. The subsequent steps were carried out in a manner similar to that those in the Example 1 to obtain a cobalt ferrite magnetic powder (having a composition of Co_{0.6}Fe₂O₄, a substantially cubic shape, and an average particle size of 16.4 nm).

A magnetic tape was obtained in a manner similar to that in the Example 1 except that the cobalt ferrite magnetic powder obtained as described above was used as the magnetic powder and the magnetic field of the magnetic powder was oriented in the longitudinal direction of the PEN film in the step of deposition.

### Comparative Example 1

A magnetic tape was obtained in a manner similar to that in the Example 2 except that a cobalt ferrite magnetic powder (having a composition of CoFe₂O₄, a substantially cubic shape, and an average particle size of 20.4 nm) having a multiaxial crystal magnetic anisotropy was used as the magnetic powder.

### Comparative Example 2

A magnetic tape was obtained in a manner similar to that in the Example 1 except that a barium ferrite magnetic powder (having a composition of BaFe₁₂O₁₉, a hexagonal plate shape, and an average particle size (average plate diameter) of 25.0 nm) was used as the magnetic powder to prepare a coating material for forming a magnetic layer.

(Evaluation of Saturation Magnetization σs of Magnetic Powder)

The saturation magnetization Gs of the magnetic powder used for the magnetic tapes according to the Examples 1 and 2 and the Comparative Examples 1 and 2 were obtained by the method described in the above-mentioned embodiment. The results are shown in Table 1.

(Evaluation of coercive force Hc, magnetocrystalline anisotropy constant Kᵤ, thermal stability Δ, activation volume V_{act}, and ratio L4/L2)

The coercive force Hc, the magnetocrystalline anisotropy constant Kᵤ, the thermal stability Δ, the activation volume V_{act}, and the ratio L4/L2 of each of the magnetic tapes according to the Examples 1 and 2 and the Comparative Examples 1 and 2 were obtained by the method described in the above-mentioned embodiment. The results are shown in Table 1. Note that the measurement of the above-mentioned property values was performed in the magnetic tape state. Further, the magnetic torque waveform measured at the time of measurement of the ratio L4/L2 is shown in Part A of FIG. 2 (Example 2), Part B of FIG. 2 (Comparative Example 1), and Part C of FIG. 2 (Comparative Example 2).

(Evaluation of DC Erase Noise)

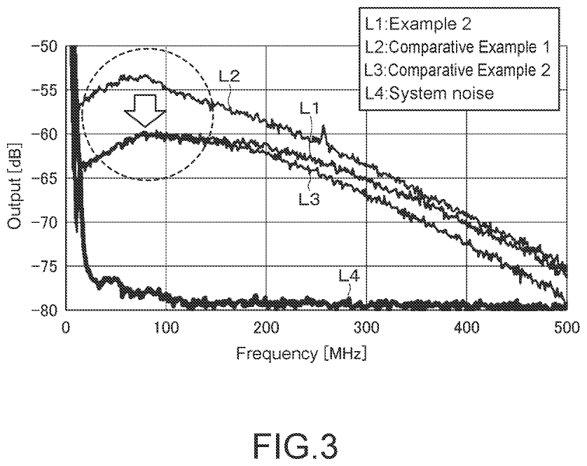

The DC erase noise of each of the magnetic tapes according to the Example 2 and the Comparative Examples 1 and 2 was measured as follows. That is, the magnetic tape was caused to travel using a commercially available ½-inch tape traveling apparatus (manufactured by Mountain Engineering II, MTS Transport), and recording and reproduction were performed using a head for a linear tape drive, thereby measuring DC erase noises in an environment of 25° C. Note that the measurement of the DC erase noise was performed by a spectrum analyzer and the DC erase was performed by applying a magnetic field to the magnetic tape with a commercially available neodymium magnet. Note that the DC erase noise means the noise generated in the case of reproducing the DC-erased (demagnetized) magnetic tape. The DC erase noise of each of the magnetic tapes according to the Example 2 and the Comparative Examples 1 and 2 is shown in FIG. 3.

Table 1 shows the configuration and evaluation results of the magnetic tapes according to the Examples 1 and 2 and the Comparative Examples 1 and 2.

TABLE 1

| | | Measure in | Measure in magnetic tape | | | | | | | |
|---|---|---|---|---|---|---|---|---|---|---|
| | | magnetic | | | | | | | Average | |
| | | powder | | | | Medium | Relative | Average | thickness | |
| | | state | | | | conversion | standard | particle | of | |
| | Magnetic | σs | Hc | Kᵤ | Δ | V_{act} | deviation | size | magnetic layer | Ratio |
| | powder | [emu/g] | [Oe] | [Merg/cm³] | (=KuV/k_{B}T) | [nm³] | σ | [nm] | [nm] | L4/L2 |
| Example | Perpendicular | 70 | 2870 | 0.35 | 126.2 | 15000 | 8.80 | 23.2 | 45 | 0.176 |
| 1 | orientation | | | | | | | | | |
| | Cobalt ferrite | | | | | | | | | |
| | (with Cu | | | | | | | | | |
| | addition) | | | | | | | | | |
| | Uniaxial crystal | | | | | | | | | |
| | magnetic anisotropy | | | | | | | | | |
| Example | Longitudinal | 62 | 3800 | 0.87 | 85.6 | 4050 | 6.02 | 16.4 | 45 | 0.037 |
| 2 | orientation | | | | | | | | | |
| | Co-Ferrite | | | | | | | | | |
| | (without Cu | | | | | | | | | |
| | addition) | | | | | | | | | |
| | Uniaxial crystal | | | | | | | | | |
| | magnetic anisotropy | | | | | | | | | |
| Comparative | Longitudinal | 62 | 4200 | Difficult to | Unmeasured | Difficult to | 5.00 | 20.4 | 46 | 3.000 |
| Example | orientation | | | measure | | measure | | | | |
| 1 | Co-Ferrite | | | | | | | | | |
| | (without Cu | | | | | | | | | |
| | addition) | | | | | | | | | |
| | Multiaxial crystal | | | | | | | | | |
| | magnetic anisotropy | | | | | | | | | |
| Comparative | Perpendicular | 51 | 2800 | 0.24 | 81.3 | 13800 | — | 25.0 | 85 | 0.013 |
| Example | orientation | | | | | | | | | |
| 2 | Ba-Ferrite | | | | | | | | | |
| | Uniaxial crystal | | | | | | | | | |
| | magnetic anisotropy | | | | | | | | | |

The following can be seen from Table 1.

In the cobalt ferrite magnetic powders (Examples 1 and 2) having a uniaxial crystal magnetic anisotropy, the saturation magnetization σs of the magnetic powder can be made higher than that of the barium ferrite magnetic powder (Comparative Example 2).

In the magnetic tapes according to the Examples 1 and 2 using the cobalt ferrite magnetic powder having a uniaxial crystal magnetic anisotropy, the magnetocrystalline anisotropy constant Kᵤ and the thermal stability Δ can be made higher than those in the magnetic tape according to the Comparative Example 2 using the barium ferrite magnetic powder.

In the magnetic tapes according to the Examples 1 and 2 using the cobalt ferrite magnetic powder having a uniaxial crystal magnetic anisotropy, the ratio L4/L2 can be reduced as compared with the magnetic tape according to the Comparative Example 1 using the cobalt ferrite magnetic powder having a multiaxial crystal magnetic anisotropy.

The following can be seen from Part A of FIG. 2, Part B of FIG. 2, and Part C of FIG. 2.

In the magnetic torque waveform (Part A of FIG. 2 and Part C of FIG. 2) of the magnetic tapes according to the Example 2 and the Comparative Example 2, the torques fluctuate at intervals of 180°. This is because each of the cobalt ferrite magnetic powder used in the magnetic tape according to the Example 2 and the cobalt ferrite magnetic powder used in the magnetic tape according to the Comparative Example 2 have a uniaxial crystal magnetic anisotropy.

Meanwhile, in the magnetic torque waveform (Part B of FIG. 2) of the magnetic tape according to the Comparative Example 1, the torques fluctuate at intervals of 90°. This is because the cobalt ferrite magnetic powder used in the magnetic tape according to the Comparative Example 1 has a multiaxial crystal magnetic anisotropy.

The following can be seen from FIG. 3.

In the magnetic tape according to the Example 2, the DC-erase noises can be reduced as compared with the magnetic tape according to the Comparative Example 1.

It is possible to reduce particularly the DC erase noise in the low frequency range.

### Modified Example

Although embodiments of the present disclosure have been specifically described above, the present disclosure is not limited to the above-mentioned embodiments and various modifications based on the technical idea of the present disclosure can be made.

For example, the configurations, the methods, the processes, the shapes, the materials, and the numerical values cited in the above-mentioned embodiments are only illustrative, and different configurations, methods, processes, shapes, materials, and numerical values may be used as necessary.

Further, the configurations, the methods, the processes, the shapes, the materials, and the numerical values in the above-mentioned embodiments can be combined without departing from the essence of the present disclosure.

Further, in the numerical value range described stepwise in the above-mentioned embodiments, the upper limit value or the lower limit value of the numerical value range at a certain stage may be replaced by the upper limit value or the lower limit value of the numerical value range at another stage. As for the materials exemplified in the above-mentioned embodiments, unless otherwise specified, one type of the materials may be used alone or two or more types of the materials may be used in combination. In addition, the chemical formulae of compounds and the like are representative ones, and the valences and the like are not limited as long as they represent common names of the same compound.

Further, although the case where the magnetic powder is oriented in the perpendicular direction has been described in the above-mentioned embodiments, the magnetic powder may be oriented in the longitudinal direction. In this case, the coercive force Hc of the magnetic recording medium 10 in the longitudinal direction is in the numerical value range similar to that of the coercive force Hc of the magnetic recording medium 10 in the perpendicular direction described in the first embodiment.

It should be noted that the present disclosure may take the following configurations.
(1) A tape-shaped magnetic recording medium, including:

a base; and

a magnetic layer that is provided on the base and includes a magnetic powder, in which

the magnetic powder includes magnetic particles that have a uniaxial crystal magnetic anisotropy and contain cobalt ferrite, and

a ratio L4/L2 of a component L4 having a multiaxial crystal magnetic anisotropy to a component L2 having a uniaxial crystal magnetic anisotropy is 0 or more and 0.25 or less, the components being obtained by applying Fourier transformation to a torque waveform of the magnetic recording medium.
(2) The magnetic recording medium according to (1), in which

a magnetocrystalline anisotropy constant Kᵤ of the magnetic recording medium is 0.1 Merg/cm³ or more and 1.5 Merg/cm³ or less.
(3) The magnetic recording medium according to (1) or (2), in which

thermal stability of (KᵤV_{act}/k_{B}T, Kᵤ: a magnetocrystalline anisotropy constant of the magnetic powder, V_{act}: an activation volume of the magnetic powder, k_{B}: a Boltzmann constant, T: an absolute temperature) of the magnetic recording medium is 60 or more.
(4) The magnetic recording medium according to any one of (1) to (3), in which

an activation volume V_{act} of the magnetic recording medium is 16000 nm³ or less.
(5) The magnetic recording medium according to any one of (1) to (4), in which

an average thickness of the magnetic layer is 40 nm or more and 90 nm or less.
(6) The magnetic recording medium according to any one of (1) to (5), in which

the magnetic powder is oriented, and

a coercive force Hc measured in a direction of the orientation is 2500 Oe or more and 4500 Oe or less.
(7) The magnetic recording medium according to any one of (1) to (6), in which

a squareness ratio of the magnetic recording medium in a perpendicular direction is 65% or more.
(8) The magnetic recording medium according to any one of (1) to (7), in which

the cobalt ferrite has an inverse-spinel crystalline structure.
(9) The magnetic recording medium according to any one of (1) to (8), in which

some Cos contained in the cobalt ferrite are substituted with at least one selected from the group consisting of Zn, Ge, and a transition metal element other than Fe.
(10) The magnetic recording medium according to any one of (1) to (9), in which

a saturation magnetization σs of the magnetic powder is 55 emu/g or more.
(11) The magnetic recording medium according to any one of (1) to (10), in which

an average particle size of the magnetic powder is 10 nm or more and 25 nm or less.
(12) The magnetic recording medium according to any one of (1) to (11), in which

a relative standard deviation of the magnetic powder is 50% or less.
(13) The magnetic recording medium according to any one of (1) to (12), in which

the magnetic powder is oriented in a perpendicular direction.

### REFERENCE SIGNS LIST

10 magnetic recording medium

11 base

12 underlayer

13 magnetic layer

14 back layer

1. A tape-shaped magnetic recording medium, comprising:
a base; and
a magnetic layer that is provided on the base and includes a magnetic powder, wherein
the magnetic powder includes magnetic particles that have a uniaxial crystal magnetic anisotropy and contain cobalt ferrite, and
a ratio L4/L2 of a component L4 having a multiaxial crystal magnetic anisotropy to a component L2 having a uniaxial crystal magnetic anisotropy is 0 or more and 0.25 or less, the components being obtained by applying Fourier transformation to a torque waveform of the magnetic recording medium.

2. The magnetic recording medium according to claim 1, wherein
a magnetocrystalline anisotropy constant Kᵤ of the magnetic recording medium is 0.1 Merg/cm³ or more and 1.5 Merg/cm³ or less.

3. The magnetic recording medium according to claim 1, wherein
thermal stability of (KᵤV_{act}/k_{B}T, Kᵤ: a magnetocrystalline anisotropy constant of the magnetic powder, V_{act}: an activation volume of the magnetic powder, k_{B}: a Boltzmann constant, T: an absolute temperature) of the magnetic recording medium is 60 or more.

4. The magnetic recording medium according to claim 1, wherein
an activation volume V_{act} of the magnetic recording medium is 16000 nm³ or less.

5. The magnetic recording medium according to claim 1, wherein
an average thickness of the magnetic layer is 40 nm or more and 90 nm or less.

6. The magnetic recording medium according to claim 1, wherein
the magnetic powder is oriented, and
a coercive force Hc measured in a direction of the orientation is 2500 Oe or more and 4500 Oe or less.

7. The magnetic recording medium according to claim 1, wherein
a squareness ratio of the magnetic recording medium in a perpendicular direction is 65% or more.

8. The magnetic recording medium according to claim 1, wherein
the cobalt ferrite has an inverse-spinel crystalline structure.

9. The magnetic recording medium according to claim 1, wherein
some Cos contained in the cobalt ferrite are substituted with at least one selected from the group consisting of Zn, Ge, and a transition metal element other than Fe.

10. The magnetic recording medium according to claim 1, wherein
a saturation magnetization σs of the magnetic powder is 55 emu/g or more.

11. The magnetic recording medium according to claim 1, wherein
an average particle size of the magnetic powder is 10 nm or more and 25 nm or less.

12. The magnetic recording medium according to claim 1, wherein
a relative standard deviation of the magnetic powder is 50% or less.

13. The magnetic recording medium according to claim 1, wherein
the magnetic powder is oriented in a perpendicular direction.
